(19) United States
(12) Patent Application Publication
(10) Pub. No.: US 2024/0208023 A1
(43) Pub. Date: Jun. 27, 2024

(54) Slide Hammer

(71) Applicant: Robert Bosch GmbH, Stuttgart (DE)

(72) Inventor: Daniel Newkirk, Owatonna, MN (US)

(21) Appl. No.: 18/506,408

(22) Filed: Nov. 10, 2023

Related U.S. Application Data
(60) Provisional application No. 63/476,699, filed on Dec. 22, 2022.

(51) Int. Cl. B25D 1/16; B25D 1/12

(52) U.S. Cl. CPC B25D 1/16; B25D 1/12

(57) ABSTRACT

A slide hammer is proposed comprising a shank and a hammer, the hammer being slidably arranged on the shank. The shank comprises a handle at a first axial end and a tool attachment interface at a second axial end opposite from the first axial end. The shank further comprises a first axial stop for the hammer. At least a first shock absorber is arranged between the hammer and the stop to absorb a shock when the hammer impacts the stop.

### TECHNICAL FIELD

This disclosure relates generally to a slide hammer. More particularly, the present disclosure relates to a slide hammer for servicing components such as vehicle components, for example, wheel hubs, brake drums and brake rotors.

### BACKGROUND

One versatile tool which has a slide hammer and several pulling attachments to give a user various methods for pulling, maintenance, and repair applications is the OTC Silver Slapper 8-Way Slide Hammer Puller Set, SKU: 1179 (www.otctools.com/products/silver-slapper-8-way-slide-hammer-puller-set). During use, a slide hammer's impact may be hard on the hands of a user.

### SUMMARY

One aspect of this disclosure is directed to a slide hammer comprising: a shank and a hammer, the hammer being slidably arranged on the shank, the shank comprising a handle at a first axial end and a tool attachment interface at a second axial end opposite from the first axial end, the shank further comprising at least a first axial stop for the hammer, wherein at least a first shock absorber is arranged between the hammer and the first axial stop to absorb a shock when the hammer impacts the first axial stop. Such a slide hammer may result in a vibration-isolating design that flexes during impact and softens the shock to a user's hand. The design may still deliver the same energy during its strike but reduces or even prevents the sudden—and possibly painful—stop a user's hand experiences. This may be especially important for heavy duty applications.

In some embodiments, the hammer defines an axial through bore, wherein a tube is slidably arranged on the shank and slidably arranged in the axial through bore, and the at least first shock absorber is arranged on the tube. The first shock absorber may be arranged at a first axial end of the tube. The tube may have a first axial end on which a first nut is arranged, and the first nut axially secures the first shock absorber between the first axial end of the tube and the hammer. The first shock absorber may comprise rings selected from the group consisting of rubber rings and disk springs.

In some embodiments, the hammer defines an axial through bore and a first aperture at a first axial end, the first aperture having a bigger diameter than the axial through bore, and the at least first shock absorber is arranged in the first aperture. The first aperture may have a first shoulder, and the at least first shock absorber is axially arranged between the first shoulder and the first nut. The at least first shock absorber and the first aperture may define a gap.

In some embodiments, a second shock absorber is arranged on a second axial end of the tube. The second shock absorber may comprise rings selected from the group consisting of rubber rings and disk springs. The tube may have a second axial end on which a second nut is arranged, and the second nut axially secures a second shock absorber between the second axial end of the tube and the hammer.

In some embodiments, the hammer defines a second aperture at a second axial end, the second aperture having a bigger diameter than the axial through bore, and wherein a second shock absorber is arranged in the second aperture. The second aperture may have a second shoulder, and wherein the second shock absorber is axially arranged between the second shoulder and the second nut. The second shock absorber and the second aperture may define a gap.

In some embodiments, a diameter of the first axial stop may be smaller than an outer diameter of the tube. A second axial stop may be arranged on the shank between the hammer and the tool attachment interface. The diameter of the second axial stop may be smaller than an outer diameter of the tube. In some embodiments.

In some embodiments, the tube is comprised of two shells that contact each other along two contact surfaces, and the contact surfaces define a plane in which a longitudinal axis of the tube is arranged.

In some embodiments, the first axial stop is arranged between the hammer and the handle and the diameter of the second axial stop is smaller than an outer diameter of the tube.

The above aspects of this disclosure and other aspects will be explained in greater detail below with reference to the attached drawings.

### BRIEF DESCRIPTION OF THE DRAWINGS

FIG. 1 is a front view of a first slide hammer.

FIG. 2 is a longitudinal section of FIG. 1.

FIG. 3 shows a perspective view of second slide hammer.

FIG. 4 shows an exploded view of FIG. 3.

### DETAILED DESCRIPTION

The illustrated embodiment is disclosed with reference to the drawings. However, it is to be understood that the disclosed embodiment is intended to be merely an example that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

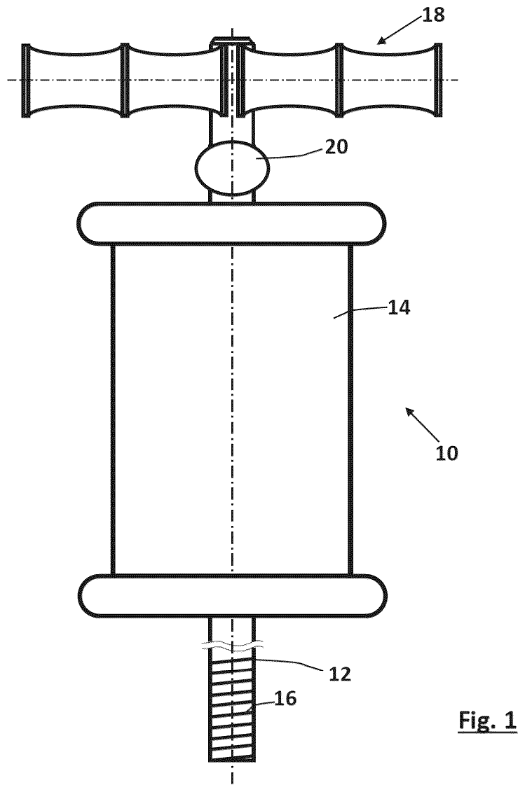

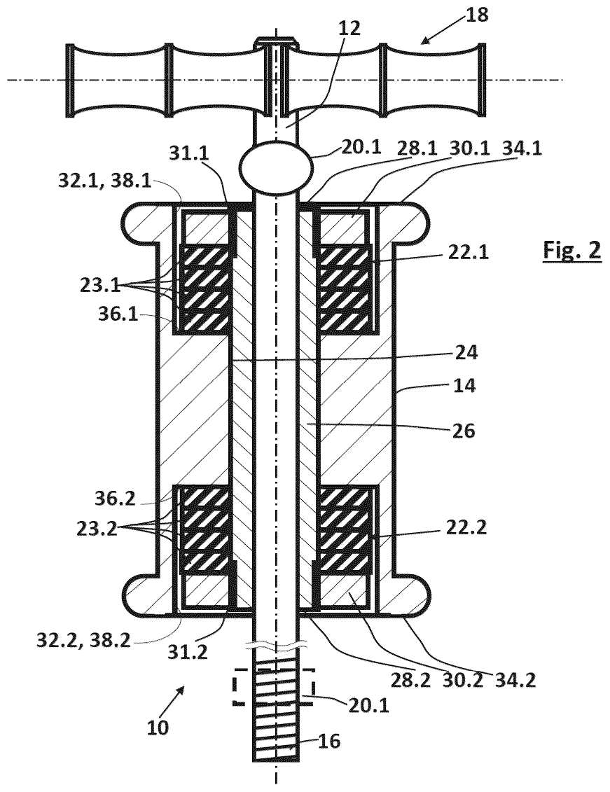

FIGS. 1 and 2 illustrate a slide hammer 10 comprising a shank 12 and hammer 14, sometimes also called the weight. The hammer 14 is slidably arranged on the shank 12 and may be of generally cylindrical shape. The slide hammer 10 has a tool attachment interface 16 at a first axial end of the shank 12. The tool attachment interface 16 may be a threaded portion of the shank 12 as shown. The slide hammer 10 has a handle 18 arranged at a second axial end of the shank 12, opposite from the first axial end. The shank 12 has a first axial stop 20.1 for the hammer 14 close to the handle 18. The first axial stop 20.1 is arranged between the hammer 14 and the handle 18. The handle 18 is a T-handle and extends away with a half of it on either radial side of the shank 12. At least a first shock absorber 22.1 is arranged between the hammer 14 and the first axial stop 20.1. The first shock absorber 22 .1 is configured to absorb a shock when the hammer 14 impacts the first axial stop 20.1. When a user slides the hammer 14 along the shank 12 and hits the first axial stop 20.1 with the hammer 14 the first shock absorber 22.1 gets compressed. That reduces the shock and vibrations impacting a user's hand and wrist. The first shock absorber 22.1 May comprise individual rings 23.1 that may be made from rubber or disk springs. The first shock absorber 22.1 may consist of rings 23.1 made of rubber rings or disk springs or a combination depending on the properties the shock absorber 20.1 should have when in use.

The hammer 14 defines an axial through bore 24. A tube 26 is slidably arranged in the through bore 24 and is also slidably arranged on the shank 12. This allows the hammer 14 to slide on the shank 12. A diameter of the first axial stop 20.1 is smaller than an outer diameter of the tube 26. The first shock absorber 22.1 is arranged on the tube 26. In particular, the first shock absorber 22.1 is arranged at a first axial end 28.1 of the tube 26.A first nut 30.1 is arranged on the first axial end 28.1 via a thread 31 to secure the shock absorber 22.1 between the first axial end 28.1 of the tube 26 and the hammer 14. The hammer 14 defines a first aperture 32 at a first axial end 34.1 extending into the hammer 14. The first aperture 32 has a bigger diameter than the axial through bore 24. The first shock absorber 22.1 is arranged in the first aperture 32.1. The first aperture 32.1 has a first shoulder 36.1. The first shock absorber 22.1 is axially arranged between the first shoulder 36.1 of the first aperture 32 and the first nut 30.1. The first shock absorber 22.1 and the first aperture 32.1 define a gap 38.1. The gap 38.1 may have the shape of a ring. This may allow the rings 23.1 to expand radially when they are axially compressed. If the external shape of the first nut 30.1 is hexagonal the first gap 38.1 should be sufficiently big for a corresponding hexagonal socket of a wrench to be inserted.

The slide hammer 10 comprise a second axial stop 20.2 (hinted at in dashed lines) may be arranged on the shank 12 between the hammer 14 and the tool attachment interface 16. The second axial stop 20.2 may be a nut mounted on a threaded portion of the tool attachment interface 16. The diameter of the second axial stop 20.2 is also smaller than an outer diameter of the tube 26. The tube 26 has a second axial end 28.2 at which a second shock absorber 22.2 is arranged. At the second axial end 28.2 a second nut 30.2 is arranged to axially secure the second shock absorber 22.2 between the second axial end 28.2 of the tube 26 and the hammer 14. The second shock absorber 22.2 comprises rings 23.2 that are selected from the group consisting of rubber rings and disk springs in the same way as the rings 23.1. The hammer 14 defines a second aperture 32.2 at a second axial end 34.2. The second aperture 32.2 also has a bigger diameter than the axial through bore 24. The second shock absorber 22.2 is arranged in the second aperture 32.2. The second aperture 32.2 has a second shoulder 36.2 at its bottom. The second shock absorber 22.2 is axially arranged between the second shoulder 36.2 and the second nut 30.2. The second shock absorber 22.2 and the second aperture 32.2 define a gap 38.2.

Instead of the first shock absorber 22.1 at one end and the second shock absorber 22.2 at the opposite end of the hammer 14, the slide hammer 10 may also comprise just one single first shock absorber 22.1. This may lower the overall cost. Two shock absorbers make it possible to use the slide hammer 10 with shock absorption when using it in both sliding directions.

The slide hammer 10 may reduce or even eliminate discomfort associated with slide hammer use. This may be especially applicable with increasing (heavy-duty) slide hammers used on large equipment. When a slide hammer assembly has rubber/steel springs inside they may absorb the shock when using the slide hammer in heavy-duty applications and reduce or even eliminate hand injury/discomfort from hard impacts.

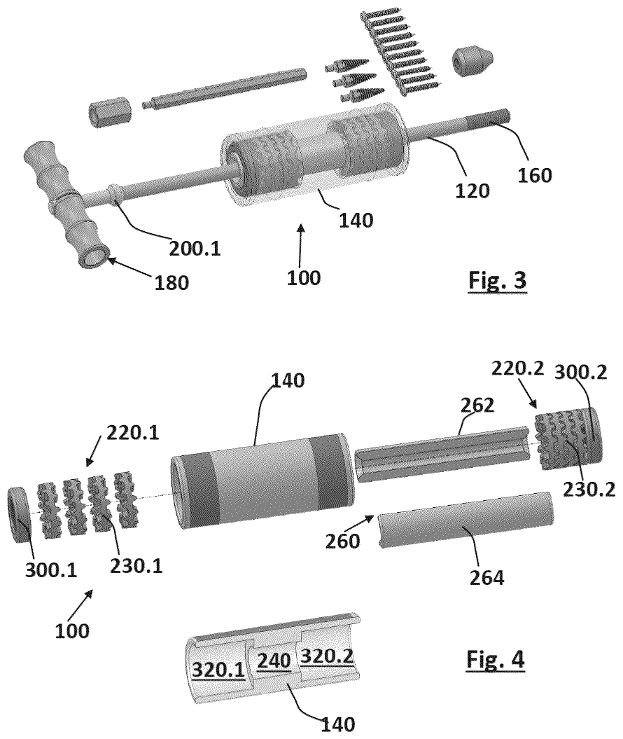

FIGS. 3 and 4 depict a slide hammer 100 comprising a shank 120 and hammer 140. Compared to FIGS. 1 and 2 a “0” is added to reference numbers of parts and components that have a similar function. The hammer 140 is slidably arranged on the shank 120. The slide hammer 100 has a tool attachment interface 160 at a first axial end of the shank 120. FIG. 3 also depicts some optional tools that may be attached to the tool attachment interface 160. The tool attachment interface 160 may be a threaded portion of the shank 120 as shown. The slide hammer 100 has a handle 180 arranged at a second axial end of the shank 120, opposite from the first axial end. The shank 120 has a first axial stop 200.1 for the hammer 140 close to the handle 180. A tube 260 is comprised of two shells 262 and 264 that contact each other along two contact surfaces. The contact surfaces define a plane in which a longitudinal axis of the tube 260 is arranged. The hammer 140 has a through bore 240 and on either axial end a first aperture 320.1 and a second aperture 320.2. In the first aperture 320.1 a first shock absorber 220.1 is arranged. The first shock absorber comprises rings 230.1 which are secured with a first nut 300.1. In the second aperture 320.2 a second shock absorber 220.2 is arranged. The second shock absorber 220.2 comprises rings 230.2 which are secured with a second nut 300.2. The two shells 262 and 264 may be useful with a slide hammer that has two axial stops which both cannot be removed. This allows to slide the hammer 140 with the nut 300.1 and rings 230.1 to be slid on the shank. Next, the shells 262 and 264 are put together on the shank and inserted into the hammer 140. Then, the rings 230.2 and the nut 300.2 get inserted into the aperture 320.2. Finally, the nuts 300.1 and 300.2 are tightened to the desired torque and the assembly of the slides hammer is finished.

What is claimed is:

1. Slide hammer comprising: a shank and a hammer, the hammer being slidably arranged on the shank, the shank comprising a handle at a first axial end and a tool attachment interface at a second axial end opposite from the first axial end, the shank further comprising at least a first axial stop for the hammer, wherein at least a first shock absorber is arranged between the hammer and the first axial stop to absorb a shock when the hammer impacts the first axial stop.

2. Slide hammer according to claim 1, wherein the hammer defines an axial through bore, wherein a tube is slidably arranged on the shank and slidably arranged in the axial through bore, and wherein the at least first shock absorber is arranged on the tube.

3. Slide hammer according to claim 2, wherein the first shock absorber is arranged at a first axial end of the tube.

4. Slide hammer according to claim 2, wherein the tube has a first axial end on which a first nut is arranged, and wherein the first nut axially secures the first shock absorber between the first axial end of the tube and the hammer.

5. Slide hammer according to claim 4, wherein the hammer defines an axial through bore and a first aperture at a first axial end, the first aperture having a bigger diameter than the axial through bore, and wherein the at least first shock absorber is arranged in the first aperture.

6. Slide hammer according to claim 5, wherein the first aperture has a first shoulder, and wherein the at least first shock absorber is axially arranged between the first shoulder and the first nut.

7. Slide hammer according to claim 5, wherein the at least first shock absorber and the first aperture define a gap.

8. Slide hammer according to claim 2, wherein a second shock absorber is arranged on a second axial end of the tube.

9. Slide hammer according to claim 8, wherein the second shock absorber comprises rings selected from the group consisting of rubber rings and disk springs.

10. Slide hammer according to claim 2, wherein the tube has a second axial end on which a second nut is arranged, and wherein the second nut axially secures a second shock absorber between the second axial end of the tube and the hammer.

11. Slide hammer according to claim 10, wherein the hammer defines a second aperture at a second axial end, the second aperture having a bigger diameter than the axial through bore, and wherein a second shock absorber is arranged in the second aperture.

12. Slide hammer according to claim 11, wherein the second aperture has a second shoulder, and wherein the second shock absorber is axially arranged between the second shoulder and the second nut.

13. Slide hammer according to claim 11, wherein the second shock absorber and the second aperture define a gap.

14. Slide hammer according to claim 1, wherein the first shock absorber comprises rings selected from the group consisting of rubber rings and disk springs.

15. Slide hammer according to claim 2, wherein the first axial stop is arranged between the hammer and the handle.

16. Slide hammer according to claim 15, wherein a diameter of the first axial stop is smaller than an outer diameter of the tube.

17. Slide hammer according to claim 15, wherein a second axial stop is arranged on the shank between the hammer and the tool attachment interface, wherein the tube is comprised of two shells that contact each other along two contact surfaces, and wherein the contact surfaces define a plane in which a longitudinal axis of the tube is arranged.

18. Slide hammer according to claim 17, wherein a diameter of the second axial stop is smaller than an outer diameter of the tube.
